(19) United States
(12) Patent Application Publication
(10) Pub. No.: US 2025/0343790 A1
(43) Pub. Date: Nov. 6, 2025

(54) SEAMLESS MULTI-FACTOR AUTHENTICATION CODE TRANSFER

(71) Applicant: Dell Products L.P., Round Rock, TX (US)

(72) Inventors: Rana Amr Afifi Mohamed, New Cairo (EG); Shary Beshara, Cairo (EG); Seth Jacob Rothschild, Littleton, MA (US)

(21) Appl. No.: 18/654,470

(22) Filed: May 3, 2024

(51) Int. Cl. H04L 9/40

(52) U.S. Cl. CPC H04L 63/0853; H04L 2463/082

(57) ABSTRACT

Multiple-factor authentication in the context of multiple devices with multiple-factor transfer is disclosed. A requestor application is installed on a requestor device and a receiver application is installed on a receiver device a connection is established between the requestor device and the receiver device. Multiple-factor authentication is performed or initiated at the requestor device and, during the authentication operation, a second authentication factor is received/generated at the receiver device. The receiver device or receiver application is configured to reduce friction, such as the amount of user input required, in multiple-factor authentication operations by accessing the second-factor code at the receiver device and then transmitting the second-factor code to the requestor device. The code may be automatically entered and submitted by the requestor application at the requestor device to complete the authentication operation at the requestor device.

### TECHNOLOGICAL FIELD OF THE DISCLOSURE

Embodiments disclosed herein generally relate to authentication and authentication-related operations. More particularly, at least some embodiments relate to systems, hardware, software, computer-readable media, and methods for multi-factor authentication in the context of multiple devices with second factor authentication transfer.

### BACKGROUND

Multiple-factor authentication generally requires a user to provide more than one type of authentication factor before gaining access to a target. Multiple-factor authentication is beneficial when the primary authentication method (e.g., username/password) is compromised. Multiple-factor authentication can protect a user's data/services or the systems/data/applications a user is authorized to access from unauthorized access. Multiple-factor authentication protects data/systems because an attacker that has stolen a user's credentials would still need to gain access to the secondary authentication factor or convince the user to confirm the secondary authentication factor.

For example, banking websites encourage their users to enable multiple-factor authentication. When a user accesses their banking website on a laptop computer using multiple-factor authentication, the first authentication factor provided by the user is often a username/password. If the username/password is correct, the user is prompted to select a second authentication factor. The second authentication factor is often a code that is texted to the user's mobile device.

An authenticator such as Authy, Duo, SecurID, Microsoft or Google Authenticator are also used for the second authentication factor in multiple-factor authentication. If the user selects an authenticator rather than a text message, the user is required to open the authenticator and select the relevant application in order to view the second authentication factor, which is typically a 6 to 8 digit code.

While multiple-factor authentication provides improved protection compared to only using a username/password combination, using the second authentication factor may require some manual effort, which is referred to as friction. For example, the user's mobile phone may be forgotten in another room. The user must get up and retrieve their mobile phone in order to view the code sent via text or in their authenticator. In addition, the user is required to read and remember the code in order to type the code into the browser or other application that is open on their laptop computer. This becomes more difficult as the number of digits in the secondary authentication code increases. Because codes often expire, a user may also have issues with entering the code before the code expires.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of multiple-factor authentication in the context of multiple devices;

FIG. 2 discloses aspects of user interfaces related to transmitting a second authentication factor from one device to another device;

FIG. 3 discloses aspects of performing a multiple-factor authentication method in the context of multiple devices that includes the transmission of a second authentication factor from one device to another device; and

FIG. 4 discloses aspects of a computing device, system, or entity.

### DETAILED DESCRIPTION OF SOME EXAMPLE EMBODIMENTS

Embodiments disclosed herein generally relate to multiple-factor authentication (MFA). More particularly, at least some embodiments disclosed herein relate to systems, hardware, software, computer-readable media, and methods for MFA using multiple devices and the seamless transmission of second authentication factors from one device to another device. Embodiments of the invention further relate to reducing friction associated with MFA.

MFA generally relates to confirming that users are who they say they are in multiple ways. Typical authentication factors include something a user knows (e.g., their password), something the user has (e.g., a phone or a hardware key), or something the user is (e.g., biometrics such as fingerprint or face scan). As previously stated, implementing MFA protects a user in the case that one of the user's authentication factors is compromised.

Embodiments of the invention relate to performing MFA in the context of multiple devices in a manner that reduces friction. Friction can be reduced by reducing the number of keystrokes required from a user, performing authentication actions or inputs automatically, or the like.

Embodiments of MFA disclosed herein may be implemented in phases. Example phases or stages may include an installation phase, a connection or pairing phase, and an operational phase. Some of these phases may be performed once or less frequently than other phases. For example, the installation phase and the connection or pairing phase are typically performed a single time, but may be repeated if necessary (e.g., updates, device additions/removals/changes).

The installation phase may be performed by installing a requestor application on a requestor device (e.g., a laptop computer) and a receiver application on a receiver device (e.g., a mobile or smartphone). The requestor application can be installed at various times. For example, the laptop may be configured to install the requestor application when turned on for the first time or by prompting the user to install the requestor application when the laptop is turned on for the first time. The user can also download the requestor application at a later time. The receiver application can similarly be installed by default or downloaded at a later time.

After the applications are installed, a connection or pairing phase may be performed. In the connection phase, the requestor application may be configured to initiate a connection or pairing process. In one example, the requestor application pairs the laptop (the requestor device) with the phone (the receiver device) using Bluetooth. In one example, the requestor application may require a more secure pairing operation. For example, pairing that requires a code to be confirmed on each of the requestor device and the receiving device may be required.

Pairing is typically a one-time process. Once the requestor device and the receiver devices are paired or connected, the connection may be restored automatically when the receiver device is within range of the requestor device. If the receiver device is physically connected (e.g., for charging, accessing, or the like) to the requestor device, the physical wire connection may also be used in embodiments of the invention.

After the installation phase and the connection or pairing phase are completed, an operational phase may be performed. The operational phase may be performed whenever the requestor application is triggered/accessed/started. For example, a user may attempt to access resources (e.g., storage, a database) on a company network. The access may require the user to be authenticated using MFA. Thus, a prompt may appear on the user's laptop computer for a first authentication factor. The user may enter their username/password into the prompt.

If the first authentication factor is successful, a prompt may appear for a second authentication factor. The prompt may include a field for inputting a code, which may have been send via text to the receiver device or can be obtained from an authenticator on the receiver device.

The user may open an authenticator on the receiver device (which may be a type of MFA authenticator), enter a PIN (or use fingerprint/facial identification), and copy the required code to the clipboard of the receiver device. The receiver application may be opened and the code is pasted into or acquired from the clipboard by the receiver application. The user presses a send button presented by the receiver application and the code acquired from the authenticator is transmitted to the laptop device using the previously established connection and automatically entered into the form field using an auto-typing library. The user can then click on sign-on to complete the MFA and access the resource in this example. A similar MFA may be used for other scenarios such as accessing a service over the internet, or the like. In these examples, the friction is reduced. In one example, the user may need to press (click) a few buttons. For example, the user may be required to click on a copy button in the authenticator to copy the code to the clipboard and click a send the code button in the receiver application to retrieve the code from the clipboard and transmit the code to the requestor application. Advantageously, the user is relieved of the need to manually input the digits in the code and may not need to even read the code.

Embodiments of the invention may copy a code, which is an example of a second authentication factor, to a clipboard or other memory from text messages or from authenticator applications. The copied code may be retrieved from the clipboard and transmitted to the requestor device. In one example, the code received by the requestor application from the receiver application is not copied into a general memory or clipboard at the requestor application. The code is received by the requestor application and stored in the memory allocated to the requestor application. This ensures that other applications, which could include malicious applications, cannot access the code. However, embodiments of the invention may allow the code received from the receiver application to be copied into a general memory or clipboard at the requesting device.

Embodiments of the invention allow the code to be copied and transmitted without exposing the code visually at the receiving device. However, the code is often presented in plain text in authenticators and in text messages due to the need for the user to type in the code. This can be avoided in embodiments of the invention and may prevent some attack such as over-the-shoulder attacks.

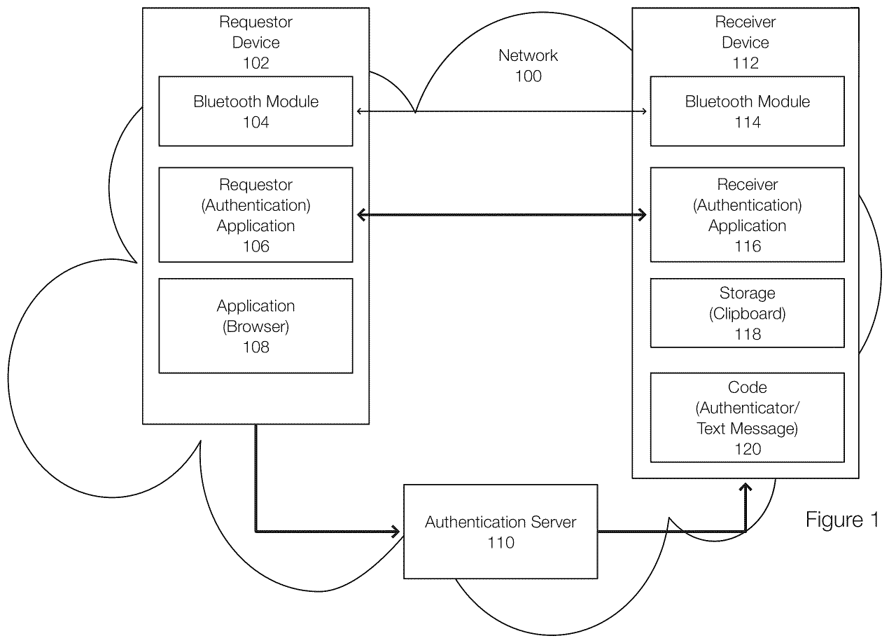

FIG. 1 discloses aspects of multiple-factor authentication in the context of multiple devices and device-to-device code transmission. FIG. 1 illustrates a requestor device 102 and a receiver device 112, which may have access to a network 100. For example, the requestor device 102 may be a laptop computer, a desktop computer, or other computing device with a processor, memory, and other hardware. the receiver device 112 may be a different type of device such as a smartphone, a tablet device, or the like. However, the requestor device 102 and the receiver device 112 can be the same type of device or different types of device.

The network 100 may represent a local area network, the Internet, cellular systems, or the like or combinations thereof. The requestor device 102 and the receiver device 112 May be connected to the same or different networks.

In one example, a requestor application 106 is installed on the requestor device 102 and a receiver application 116 is installed on the receiver device 112. The requestor device 102 includes a Bluetooth module 104 and the receiver device 112 includes a Bluetooth module 114. During the execution of the requestor application 106 and/or the receiver application 116, a connection or pairing between the requestor device 102 and the receiver device 112 is established. When the connection is a Bluetooth connection, a connection between the requestor device 102 and the receiver device 112 is typically established (or reestablished) when the devices are within range of each other. Although embodiments of the invention are discussed in the context of Bluetooth, other connections using other protocols may be used. In one example, the connection or pairing may support encryption, be a direct connection, and may have a limited transmission range.

In FIG. 1, the installation and connection or pairing phases have been accomplished and FIG. 1 more specifically illustrates an operational authentication phase. This example assumes that a Bluetooth connection is present and that the devices are within range of each other for Bluetooth transmission/communication.

In this example, an application 108 is executing on the requestor device 102. The requestor application 106 may also be running on the requestor device 102. If the application 108 is a browser, the user may be accessing a website, resources on the network 100, or the like. In one example, a situation arises in which authentication is required. This may occur, for example, if the user attempts to access a bank account using the browsing application 108. A field appears in the application for the user to enter a first authentication factor (e.g., username/password). When performed correctly, a second authentication factor prompt or box may be presented to the user in a display.

The prompt for the second authentication factor can take various forms. For example, the user may be presented to select the manner in which the MFA code should be received/acquired (e.g., using an authenticator, using text message). After making a selection, a field may be presented to the user in the user interface and the user is expected to enter a code from the authenticator or text message into the field. The requestor device 102 or, more specifically the application 108, may communicate with an authentication server 110 to perform the MFA.

More specifically, the first authentication factor received from the user via a user interface is provided to the authentication server 110 for verification. If verified, a second authentication factor may be required before the user is authenticated.

This example uses something the user has (e.g., a smartphone) to perform the second factor authentication. In one example, a code will be available at the receiver device. The code may be present in an authenticator application on the receiver device 112, received in a text message at the receiver device 112, or the like. Thus, the code 120 is available at the device once the user requests the code at the requestor device 102.

The code received via text or present in the authenticator may be copied to a storage 118 such as a clipboard of the receiver device 112. In one example, a user may use a copy function of the texting application or the authenticator to copy the code to the storage 118. Alternatively, the code 120 may be automatically moved to the storage 118 upon receipt (e.g., for text messages). A user may be required to open the authenticator as the authenticator May be configured to provide MFA for multiple applications.

More specifically in one example, once the requestor device 102 needs an MFA code, the user will log into or access receiver device 112 and copy the MFA code into the receiver device's clipboard (using a copy button present in the MFA application (e.g., an authenticator). As an example, if the receiver device 112 is a smartphone and the MFA code was sent using an authenticator, the user will usually have to unlock the phone, select the MFA code as seen in the MFA application (the authenticator), and copy the code using the built-in functionality of the authenticator. A code received via text may be automatically copied to the clipboard. The user then selects, within the receiver application 116, to send the code 120 that has been copied into the clipboard or storage 118. When send the code is selected in the receiver application 116, the receiver application 116 obtains the code from the storage 118 and transmits the code to the requestor application 106 using, in this example, the Bluetooth connection.

More specifically in this example, the receiver application 116, which may be started by a user or already running, retrieves the code from the storage 118. The receiver application 116 may confirm that the code retrieved from the storage 118 has a proper format (e.g., is a sequence of 6 to 8 digits), encrypts (optionally) the code, and transmits the encrypted code to the requestor application 106 on the requestor device 102. The encrypted code may be received into memory of the requestor application 106 such that the code is not available to other applications.

The requestor application 106, upon receiving the code, may decrypt the code if necessary and enter the decrypted code into the field of the prompt still displayed at the requestor device 102 by the application 108. The requestor application 106 may also cause the code to be submitted to the authentication server 110 or may allow the user to click the submit button once the user determines that the MFA field is populated.
previously stated, the code may be presented in the user interface of the requestor device 102 in an obscured form (e.g., all asterisks “******”) as it is not necessary for the code to be displayed to successfully submit the code to the authentication server 110. In fact, embodiments of the invention allow the code to be obscured (e.g., not presented on a display of the requestor device 102 or the receiver device 112 in plain text) at all times.

In one example, the field for the code presented by the browser may be selected by clicking on the field such that the requestor application 106 can simply insert the code into the correct field. If the relevant code field is selected, no logic is required to determine where the code should be entered on the user interface.

Embodiments of the invention allow an MFA code to be automatically transferred from the receiver device 112 to the requestor device 102 without requiring the user to see, read, or manually type the code. Because embodiments of the invention are based in part on user possession (what the user has), it may not be strictly necessary to encrypt the code, prevent the code from being stored in plain text, or prevent the code from being displayed. For example, the authenticator or text message may receive and/or display a code in plain text during normal operation. Embodiments of the invention allow the code to be obscured if desired.

The storage 118 may be cleared automatically. However, most codes expire quickly and embodiments of the invention may place a suitable expiration time on the code. In this case, it may not be necessary to clear the storage 118 or, more specifically, delete the code from the storage 118. The code may be deleted from the memory of the requestor application 106 if desired.

Embodiments of the invention thus relate to a method to securely transfer data, like a second authentication factor or code sent to SMS, from a receiver device such as a phone with a clipboard or other storage to a requestor device such as a computer. Embodiments of the invention may be implemented at least with applications or devices that provide a copy function with respect to MFA authenticators, text messaging, or the like.

Embodiments of the invention relate to a method for requesting an authentication or authenticator code from a requestor device such as a computer such that the user is prompted with another application on a receiver device such as a phone. Embodiments of the invention allow the code to be transmitted over a direct connection (e.g., computer to phone) rather than over a network such as the Internet.

Embodiments of the invention reduce friction in MFA-related operations, make MFA more easily used on computers, and may facilitate MFA on devices where MFA is not conventionally used.

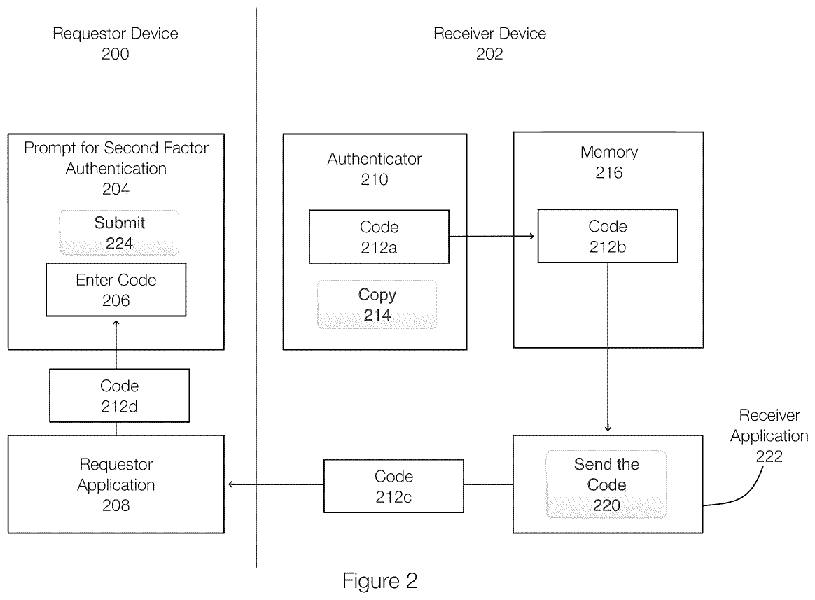

FIG. 2 discloses aspects of user interfaces related to transmitting a second authentication factor from one device to another device. FIG. 2 illustrates a requestor device 200 and a receiver device 202. In this example, a prompt for a second factor authentication 204 is presented in a display and includes a field 206 to enter code. When the prompt 204 is displayed, a code may be sent by an authentication server to the receiver device 202 or may be retrieved from an authenticator. FIG. 2 illustrates an example of retrieving the code from an authenticator.

In FIG. 2, a code 212 is represented at different times using elements 212a, 212b, 212c, and 212d. At the receiver device 202, a user interface of the authenticator 210 may display a code 212a for the application executing on the requestor device 200 that requested the second authentication factor. The authenticator 210 includes a copy button 214. When the copy button 212 is clicked or selected, the code 212a is copied into a memory 216 (e.g., a clipboard of the receiver device 202) as the code 212b.

The receiver application may present a user interface 222 that includes a send the code button 220. When the send the code button 220 is clicked or selected, the receiver application 222 retrieves the code 212b from the memory 216, encrypts (optionally) the code 212b to generate the code 212c, and transmits the code 212c to the requestor device and more specifically to the requestor application 208.

The requestor application 208 decrypts the code 212c, if necessary, and places or inserts the code 212d into the enter code field 206 of the prompt 204. The requestor application 208 may also click or select the submit button 224 or allow the user to click the submit button 224 once the enter code field 206 is populated with the code 212d.

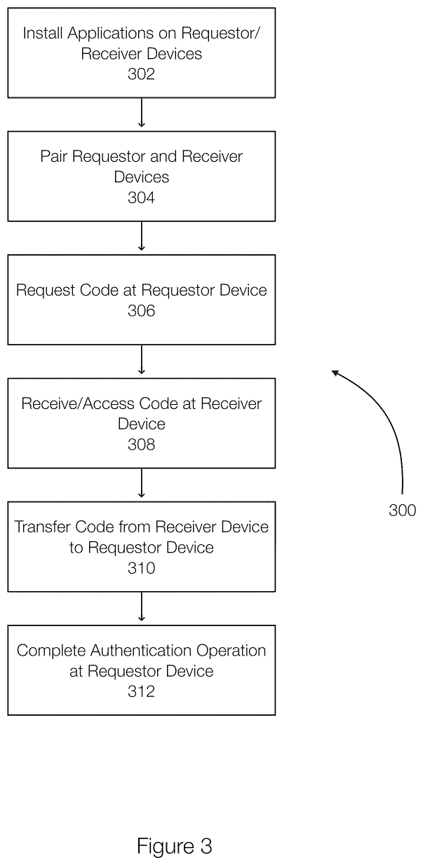

FIG. 3 discloses aspects of a method for performing MFA in the context of multiple devices. The method 300 illustrates multiple phases of MFA as disclosed herein. These phases may be performed independently and/or separately. Further, time may elapse between the times at which the phases are executed.

The method 300 illustrates an installation phase that includes installing 302 applications on requestor devices and receiver devices. For instance, a user may install a requestor application on a laptop device and install a receiver application on a smartphone. This may be done at the same time or at different times.

When the requestor application is launched, the requestor application may perform a connection or pairing phase. In one example, the requestor device is paired 304 (e.g., a Bluetooth pairing) with the receiver device. This may be performed within the context of the applications or separately. Thus, the requestor device may use a Bluetooth connection or other connection to the receiver device that was established prior to the installation phase. However, embodiments of the invention may require a pairing to be performed or to verify that a previously established Bluetooth connection exists between the requestor device and the receiver device. The connection or pairing, in one example, includes encryption.

The operational phase of the method 300 may include requesting 306 a code at a requestor device. In one example, the requestor application operating on the requestor device may detect that MFA is being performed and that a second authentication factor (e.g., a code) is required. This may be detected automatically may and allow the requestor application to expect that a code will be received.

However, it may not be necessary for the requestor application to specifically request a code because, in some embodiments, the requestor application may only be required to wait for a transmission from the receiver application. The requestor application may operate to ensure that a connection is available with the receiver device and then wait for a code. When a code is received, the code is inserted into the appropriate field and submitted to the authentication server.

In one example, requesting 306 a code at the requestor device may also aspects related to execution of an application ion which authentication is being performed. Thus, requesting a code 306 may include receiving input from a user to select a manner in which the code will be received/determined at the receiving device.

In one example, the code is received/accessed 308 at the receiver device. For example, a text message may be received at the receiver device that includes the code or an authenticator application on the receiver device may be accessed by a user. In either case, the code may be copied to a clipboard of the receiver device automatically of in response to user input. For example, a user may press a copy button in the authenticator to copy the code to the clipboard. The receiver application may be opened and the user may be verified using a fingerprint, facial identification, or the like. When the receiver application is opened (the receiver application may already be open in one example), the code is accessed from the clipboard or other memory and transmitted 310 to the requestor device.

More specifically, a user may access the receiver application and press a “send the code” button or provide other input to send an MFA code to the requestor application. When this is performed, the receiver application accesses the location or storage at which codes are stored (e.g., the clipboard) verifies that the code is an MFA code (e.g., 6 to 8 digits), encrypts the code, and transmits 310 the code to the requestor application on the requestor device.

The authentication operation is then completed 312 at the requestor device. The requestor device (or requestor application) may receive the code into its own memory, decrypt the code, and insert the code into the relevant field in the user interface or prompt requesting the code. The requestor application may allow the user to submit the code or the requestor application may cause the code to be submitted automatically to the authentication server. If the correct code is submitted, access, permission, or other appropriate action is taken based on context. For example, access to a user's bank accounts is granted if the user is attempting to access a banking website. Access to company resources is granted if the user is attempting to access protected resources. Permission to execute an application in a company system may be granted when MFA is completed successfully.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, authentication operations, MFA authentication operations, code transmission operations, multiple device MFA authentication operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that may be capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, appliances, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operations of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: accessing, on a receiver device by a receiver application, a memory of the receiver device that stores a code representing a second authentication factor in a multiple-factor authentication operation performed to authenticate a user, transmitting the code to a requestor application executing on a requestor device, and inserting, by the requestor application, the code into a prompt for the code displayed on the requestor device, wherein the code is submitted to an authentication server for verification and the user is authenticated when the code is correct.

Embodiment 2. The method of embodiment 1, wherein the code is copied into the memory from an authenticator operating on the receiver device or from a text message received at the receiver device.

Embodiment 3. The method of embodiment 1 and/or 2, wherein the memory comprises a clipboard of the receiver device.

Embodiment 4. The method of embodiment 1, 2, and/or 3, further comprising encrypting the code by the receiver application prior to transmitting the code to the requestor application.

Embodiment 5. The method of embodiment 1, 2, 3, and/or 4, further comprising receiving input from the user to copy the code in the authenticator or received via a text message.

Embodiment 6. The method of embodiment 1, 2, 3, 4, and/or 5, further comprising receiving input from the user to send the code in the receiver application.

Embodiment 7. The method of embodiment 1, 2, 3, 4, 5, and/or 6, further comprising installing the requestor application on the requesting device and installing the receiver application in the receiver device.

Embodiment 8. The method of embodiment 1, 2, 3, 4, 5, 6, and/or 7, further comprising connecting or pairing the requesting device with the receiver device such that the requesting device has a direct connection with the receiver device.

Embodiment 9. The method of embodiment 1, 2, 3, 4, 5, 6, 7, and/or 8, further comprising transmitting the code over the direct connection, wherein the direct connection is configured to connect automatically when the receiver device is within range of the requestor device.

Embodiment 10. The method of embodiment 1, 2, 3, 4, 5, 6, 7, 8, and/or 9, wherein the direct connection is a Bluetooth connection.

Embodiment 11. The method of embodiment 1, 2, 3, 4, 5, 6, 7, 8, 9, and/or 10, wherein the code is obscured at least part of the time during the multiple-factor authentication operation.

Embodiment 12. A system, comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-11.

The embodiments disclosed herein may include the use of a special-purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general-purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special-purpose computer, or special-purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

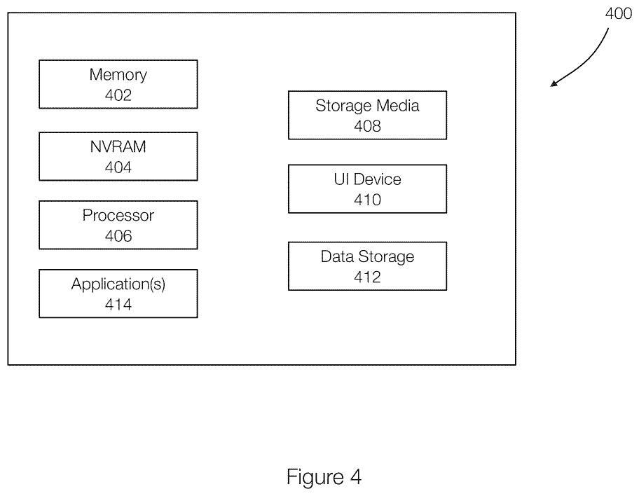

With reference briefly now to FIG. 4, any one or more of the entities disclosed, or implied the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
accessing, on a receiver device by a receiver application, a memory of the receiver device that stores a code representing a second authentication factor in a multiple-factor authentication operation performed to authenticate a user;
transmitting the code to a requestor application executing on a requestor device; and
inserting, by the requestor application, the code into a prompt for the code displayed on the requestor device, wherein the code is submitted to an authentication server for verification and the user is authenticated when the code is correct.

2. The method of claim 1, wherein the code is copied into the memory from an authenticator operating on the receiver device or from a text message received at the receiver device.

3. The method of claim 2, wherein the memory comprises a clipboard of the receiver device.

4. The method of claim 1, further comprising encrypting the code by the receiver application prior to transmitting the code to the requestor application.

5. The method of claim 1, further comprising receiving input from the user to copy the code in the authenticator or received via a text message.

6. The method of claim 5, further comprising receiving input from the user to send the code in the receiver application.

7. The method of claim 1, further comprising installing the requestor application on the requesting device and installing the receiver application in the receiver device.

8. The method of claim 1, further comprising connecting or pairing the requesting device with the receiver device such that the requesting device has a direct connection with the receiver device.

9. The method of claim 8, further comprising transmitting the code over the direct connection, wherein the direct connection is configured to connect automatically when the receiver device is within range of the requestor device.

10. The method of claim 1, wherein the direct connection is a Bluetooth connection.

11. The method of claim 1, wherein the code is obscured at least part of the time during the multiple-factor authentication operation.

12. A non-transitory storage medium having stored therein instructions that are executable by one or more hardware processors to perform operations comprising:
accessing, on a receiver device by a receiver application, a memory of the receiver device that stores a code representing a second authentication factor in a multiple-factor authentication operation performed to authenticate a user;
transmitting the code to a requestor application executing on a requestor device; and
inserting, by the requestor application, the code into a prompt for the code displayed on the requestor device, wherein the code is submitted to an authentication server for verification and the user is authenticated when the code is correct.

13. The non-transitory storage medium of claim 12, wherein the code is copied into the memory from an authenticator operating on the receiver device or from a text message received at the receiver device.

14. The non-transitory storage medium of claim 13, wherein the memory comprises a clipboard of the receiver device.

15. The non-transitory storage medium of claim 12, further comprising encrypting the code by the receiver application prior to transmitting the code to the requestor application.

16. The non-transitory storage medium of claim 12, further comprising receiving input from the user to copy the code in the authenticator or received via a text message.

17. The non-transitory storage medium of claim 16, further comprising receiving input from a user to send the code in the receiver application.

18. The non-transitory storage medium of claim 12, further comprising installing the requestor application on the requesting device and installing the receiver application in the receiver device.

19. The non-transitory storage medium of claim 12, further comprising:
connecting or pairing the requesting device with the receiver device such that the requesting device has a direct connection with the receiver device, and
transmitting the code over the direct connection, wherein the direct connection is configured to connect automatically when the receiver device is within range of the requestor device.

20. The non-transitory storage medium of claim 12, wherein the direct connection is a Bluetooth connection, and wherein the code is obscured at least part of the time during the multiple-factor authentication operation.
